(19) United States
(12) Patent Application Publication
(10) Pub. No.: US 2024/0339886 A1
(43) Pub. Date: Oct. 10, 2024

(54) Can for an Electric Rotating Machine

(71) Applicant: Siemens Aktiengesellschaft, München (DE)

(72) Inventors: David Finck, Forchheim (DE); Christian Seidel, Baiersdorf (DE); Günther Winkler, Freinberg (DE)

(73) Assignee: Siemens Aktiengesellschaft, München (DE)

(21) Appl. No.: 18/579,290

(22) PCT Filed: Jul. 4, 2022
(86) PCT No.: PCT/EP2022/068456

§ 371 Date: Jan. 12, 2024

(30) Foreign Application Priority Data
Jul. 13, 2021 (DE) 10 2021 207 416.2

(51) Int. Cl. H02K 5/16; H02K 5/10

(52) U.S. Cl. CPC H02K 5/16; H02K 5/10

(57) ABSTRACT

Various embodiments of the teachings herein include a can for an electric rotating machine. An example can includes: a bearing seat; and an asymmetric element on the can and/or on the bearing seat. The asymmetric element counteracts an expected deformation in loaded regions of the can, the expected deformation identified by measurement data and/or deformation simulation calculated in advance.

### CROSS-REFERENCE TO RELATED APPLICATIONS

This application is a U.S. National Stage Application of International Application No. PCT/EP2022/068456 filed Jul. 4, 2022, which designates the United States of America, and claims priority to DE Application No. 10 2021 207 416.2 filed Jul. 13, 2021, the contents of which are hereby incorporated by reference in their entirety.

### TECHNICAL FIELD

The present disclosure relates to rotating machines. Various embodiments of the teachings herein include cans for an electric rotating machine, an electric motor, or a liquid pump, and/or production methods.

### BACKGROUND

Increasing the power density of electric motors is becoming ever more important in the development of electric motors. A determining factor for the electrical power output of an electric motor is the heat generated by the electrically conducting components and the accompanying disadvantages. One disadvantage may be the failure of the polymeric insulation of the winding coils as from a certain operating temperature. The maximum operating temperature in the stator winding is a determining factor for the maximum electrical loading capacity of an electric machine.

With the increase in the power density of electric motors, there is a clear trend away from air cooling to liquid cooling. Instances of jacket cooling of the stator are already showing good cooling results here. Even better cooling of the critical stator windings can be achieved however with a can construction, in which a cooling liquid circulates on the inner side of the coils. To avoid frictional losses of the rotor in the liquid, it is essential to place in the air gap a so-called can, which separates the liquid from the rotor region. The sealing region of the can in the air gap comprises a groove, which runs around the rotor region and in which the so-called O-rings are fitted, for the mounting and sealing of the can.

An electric machine with a greater power density shows clear advantages in the area of mobile use. The more compact construction allows easier installation positions and the higher power density also indirectly conforms to the concept of lightweight construction, since a smaller electric machine can be used for the power required. However, advantages are also evident in stationary applications, such as for example in wind turbines. Here, the smaller mass of the generator means that the entire tower structure can be made less massive. Also, the thermal service life of the stator windings used can be estimated better and prolonged as a result of the better heat removal.

The structural requirements demanded of a can are:
Smallest possible thickness: the thicker the can is, the greater the magnetic losses of an electric machine become. Increasing magnetic losses reduce the efficiency.
a.) Highest possible dimensional stability under external pressure: the circulating cooling liquid causes the load of an external pressure to act on the can. The compressive load deforms the can. The reason for the uneven pressure distribution is the hydrostatic liquid pressure, which changes depending on the difference from the surface. Allowance for the deformation of the can is made in the air gap width, and this deformation therefore increases the magnetic losses. The maximum system pressure is in this case made up of variable components, such as acceleration, punctures . . . , and constant components, such as gravitational loading by the liquid column.
b.) Highest possible buckling stability: the requirement of great stiffness with respect to external pressure coincides with item b). For the design of the can, however, it is decisive that the external pressure does not lead to buckling of the can when it is overloaded. Stiffer materials and greater wall thicknesses have the effect of shifting the buckling point of the can toward higher pressures.
c.) Electrical conductivity: since the can in the air gap is exposed to changing magnetic fields, the electrical conductivity of the can should be as low as possible. The induction of eddy currents has the effect of heating the can and reducing the electrical efficiency of the motor.
d.) The greater pressure on the underside of the can, in comparison with the upper side of the can, makes the can float in the soft elastomer mounting, usually in the form of a classic O-ring mounting. The radial position of the can in the electric motor changes as a result, unfavorably with respect to the size of the eccentric air gap of the can.

The described requirements for a can usually lead to a fiber-plastic composite design being used for forming the can. The winding process—for example filament winding—and/or prepreg-autoclave technology are particularly suitable for this. The ultrahigh-modulus carbon fibers known from DE 10 2020 205 287, which offer extremely high stiffness, are particularly promising here. Consequently, the air gap thicknesses can be reduced for the reasons explained under b.) and c.). However, in this case the high material costs of the fibers used may be prohibitive.

### SUMMARY

The teachings of the present disclosure include cans for an electric rotating machine or electric motor or liquid pump that can be produced cost-effectively and in a way that is suitable for mass production, that is to say in a way that can be automated. For example, some embodiments include a can for an electric rotating machine, wherein, by means of measurement data and/or deformation simulation, loaded regions of the can are identified and their likely deformation with respect to the symmetrically formed can during operation can be calculated in advance, and at least one asymmetric design element counteracting this deformation is provided on the can and/or on its bearing seat.

In some embodiments, an asymmetric design element on the can is a negative form of a likely outward buckling and/or upward bending of the can.

In some embodiments, an asymmetric design element is an eccentric position of the O-rings that serve for the mounting and sealing of the can.

In some embodiments, an asymmetric design element is the arrangement and/or distribution of the fiber reinforcement within the can.

In some embodiments, the can is partly symmetrical.

In some embodiments, the can has regions with fiber reinforcement comprising glass fibers.

In some embodiments, the can has regions with fiber reinforcement comprising glass fibers in combination.

In some embodiments, the can has regions with fiber reinforcement comprising ultrahigh-modulus carbon fibers.

In some embodiments, the can entirely or partially has a complex form.

As another example, some embodiments include a can with O-ring sealing with respect to the rotor region of the electric rotating machine, wherein the O-ring sealing, at least in partial regions, is not arranged axially symmetrically in relation to the rotor axis.

As another example, some embodiments include a method of producing a can, comprising:
a) deformation simulation and/or measurement of the operating loads imparted to the dimensional stability of the can due to hydrostatic pressure, due to vibration and/or due to the counter force of the sealing O-rings,
b) generating and storing corresponding data with regard to likely particularly loaded regions of the can,
c) on the basis of these data, carrying out a calculation for determining the position of the particularly loaded regions of the can,
d) creating a virtual, possibly digital, representation of a can optimized with regard to the particularly loaded regions, wherein the regions are represented either by compacting and/or building up the fiber reinforcement, by complexity of the form and/or surface structure, and/or by an eccentric position of the O-rings, which are modified with respect to a round, axially symmetrically mounted can,
e) forming and producing a can with modifications in accordance with the specifications of the virtual, and possibly digital, representation created according to d).

In some embodiments, the method is performed in an automated manner.

In some embodiments, the method is performed by way of a winding process.

In some embodiments, the method is performed by way of a prepreg-autoclave technology.

As another example, some embodiments include the use of a can as described herein in a motor and/or a liquid pump.

### DETAILED DESCRIPTION

Various embodiments of the teachings herein include a can for an electric rotating machine, wherein, by means of measurement data and/or deformation simulation, loaded regions of the can are identified and their likely deformation with respect to the symmetrically formed can during operation can be calculated in advance, and therefore at least one asymmetric design element is provided on the can and/or on its bearing seat. Because an electric rotating machine is symmetrically constructed, it is the typical practice that all parts of the can, in particular its construction, form and/or bearing seat, are symmetrical. It has however been found that the loads to which the can and its bearing seat are subjected during operation act not only symmetrically but also asymmetrically, for example by way of gravitation and/or the pressure of the cooling liquid. Therefore, the structural design and production of a can and its bearing seat in the electric rotating machine will include a certain air gap size of the can, which includes likely deformations during operation with the intended space requirement of the can.

The teachings of the present disclosure include adding an asymmetric design element to the can. Thereby, the likely deformation of the particularly loaded regions of the can is formed as a negative form and/or an additional fiber reinforcement is provided in some regions there and/or the bearing seat or the position of the O-rings is adapted to the likely deformation. Thus, the air gap size of the can between the rotor and the stator, which is based on the deformation of the can and for which allowance is to be made in the design of the electric machine, can be reduced.

Some embodiments of the teachings herein include a method of producing a can, comprising:
a) deformation simulation and/or measurement of the operating loads imparted to the dimensional stability of the can due to hydrostatic pressure, due to vibration and/or due to the counter force of the sealing O-rings,
b) generating and storing corresponding data with regard to likely particularly loaded regions of the can,
c) on the basis of these data, carrying out a calculation for determining the position of the particularly loaded regions of the can,
d) creating a virtual, possibly digital, representation of a can optimized with regard to the particularly loaded regions, with at least one asymmetric design element, which is represented either by compacting and/or building up the fiber reinforcement, by complexity of the form and/or surface structure, and/or by modifying the conventional bearing seat,
e) forming and producing a can and/or installing the can on the sealing O-ring, with at least one asymmetric design element in accordance with the specifications of the virtual, and possibly digital, representation created according to d).

The use of at least one asymmetric design element in the production of an improved can of an electric rotating machine allows the air gap size planned for the can to be reduced. In particular, the introduction of at least one asymmetric design element in the can makes allowance for the following loads to be imparted to the dimensional stability of a can during operation:
a) increased hydrostatic pressure on the underside of the can has the effect that its round form is distorted into an oval shape,
b) buoyancy, that is to say in particular also the increased hydrostatic pressure on the underside of the can, has the effect that its axially symmetrical mounting is distorted,
c) the robust dimensional stability of the O-rings of the sealing of the can has the effect that the can is possibly bent up at the sealing location,
d) mounting of the O-rings that is not axially symmetrical and centric about the rotor axis but displaced has the effect of allowing compensation for floating of the can in the air gap, and
e) differences in the groove height of the O-ring pressing groove has the effect of allowing compensation for the compressive deformation and/or the floating of the can in the air gap.

These loads to which the dimensional stability of a can is subjected can be predicted by deformation simulation and/or recorded by measurement data quite accurately for any type of use of a can. This gives an idea of the mechanical damage due to buckling affecting the can at particularly loaded regions during operation. These buckles or bends may then be realized in the improved can as a negative form, so that there is a greater latitude during operation before failure due to buckling.

An “asymmetric design element” refers for example in the present case to a region of the can which has with respect to the symmetrical can a deformation corresponding practically to a negative form of a likely buckle in the can during operation. A further example of an asymmetric design element is a region with fiber reinforcement deviating from a uniform fiber reinforcement in the can, wherein the deviation may be realized in the material, in the position of the fibers, in the fiber combination, the fiber thickness and/or the density of fibers in the composite material or as any desired combination of the aforementioned deviations.

A further example of an asymmetric design element includes an eccentric bearing seat of the can, which may be realized by an asymmetric position, thickness and/or form of the sealing O-rings.

A further example of an asymmetric design element includes an O-ring sealing which, at least in partial regions, is not arranged axially symmetrically in relation to the rotor axis.

One or more of such examples may be realized and/or it may have one or more regions in which these examples of asymmetric design elements are realized.

In some embodiments, a mold core for automated production—for example by a winding process or by a prepreg-autoclave technology—of cans is manipulated in the direction of negative deformation, so that it is given a surface on which a can that has a pre-deformation, which during operation is pressed back again under the external pressure of the coolant, can be produced. The can is then made to assume a round form for example due to the loads during operation. Moreover, by creating a virtual representation of a can with correspondingly identified regions that must withstand higher loading, the use of expensive reinforcing fibers can be minimized, for example restricted just to those regions, without any overall sacrifice in quality.

“Prepreg” material refers here to a composite material which comprises preimpregnated fibers and a partially cured polymer matrix, such as epoxy and/or phenolic resin, or even a thermoplastic mixture with liquid rubbers and/or resins. The fibers may take the form of a combination of a number of fiber materials or individual fibers, in a preferential direction, of different lengths, bundled, braided, or woven. For example, in the prepreg, the fibers have the form of a woven fabric and the matrix is used to bond them to one another and to other components during production. The thermosetting matrix is only partially cured, in order to make easy handling possible. A prepreg is always in the B stage, that is to say the thermosetting matrix is only partially cured, not crosslinked. For curing, the prepregs require autoclave processing. The use of prepregs allows anisotropic mechanical properties to be achieved along the fiber, while the polymer matrix offers filling properties and keeps the fibers in a single system.

In some embodiments, a likely deformation and/or a likely upward bending or inward pressing is calculated in advance for the respective use of the can. These parameters are used in the production of the can in order to supplement the can at the location of the likely upward bending or inward pressing specifically with respect to the conventional can by fiber reinforcement, adapted in quality and/or alignment, and/or negative deformation such that the deformation during operation does not occur at the supplemented location, or only to a reduced extent or only after a prolonged operating time.

The “air gap size of the can” refers in the present case to the radial extent of the air gap into which the can intended for this is inserted. Allowance for the deformation of the can is also included here. This air gap size of the can for which allowance is to be made is reduced by the installation of asymmetric design parts—proposed for the first time by the present invention.

“Eccentric” refers to off-center mounting.

The bearing seat is the positioning of the can on the sealing of the O-ring.

In some embodiments, the can is not a round, radially symmetrical can but for example an ovally, or partially ovally, shaped can.

In some embodiments, the can has, in particular in the peripheral regions at the end of the can, one or more regions which are provided with built-up fiber reinforcement, that is to say for example have more and/or other fibers for reinforcement. A modified or built-up fiber reinforcement also occurs for example if there are one or more regions with a fiber reinforcement that has a different preferential direction, a different type of fiber, a different fiber material, a different fiber orientation, a different combination of fibers, etc.

In some embodiments, there may be regions of the can with simple fiber reinforcement, regions with bundled and/or braided fibers or regions with laid fiber fabrics for fiber reinforcement. Thus, fibers may be realized in the form of a simple fiber reinforcement as a fiber braid and/or as rovings.

In some embodiments, in the can there may be fiber reinforcement with different preferential directions, depending on the requirements profile of the particularly loaded regions. Thus, for example, glass fibers on their own or in combination with other fibers may be used for reinforcement. They may be used in a preferential direction or as a laid fiber fabric over the surface area. Fiber reinforcements with a braiding comprising different fibers may also be used.

In some embodiments, the can has a complex form. This may be realized by there being one or more regions which are thickened, crimped, buckled outwardly and/or buckled inwardly and outwardly in a meandering manner. In some embodiments, this region or these regions may alternate with one or more regions that are round and cylindrical.

In some embodiments, the can has a complex surface structure. In this case there is for example a region which is buckled outwardly, so that under the hydrostatic pressure, which conventionally leads to an uneven inward pressing of the can, here there is a rounding out again of the can during operation.

In some embodiments, the can is at least partially in a not axially symmetrical arrangement in relation to the rotor axis, whereby an at least partially unround or eccentric O-ring sealing with respect to the rotor region is obtained.

For production, the teachings of the present disclosure include the creation of a geometrical adaptation of the mold core, on which for example a fiber-plastic composite can is produced. This mold core is then used to produce a can that has a complex form, which however during operation is shaped into a conventional round can due to an uneven pressure distribution during operation as a result of a “restoration to the non-complex simple cylindrical form”.

In some embodiments, the can is in a negative form of the likely deformations in the form of a tube with a complex form and/or surface.

The present disclosure describes a can for an electric rotating machine that has an improved air gap size of the can and thereby results in smaller electrical losses in the electric motor.

In some embodiments, there is a can for an electric rotating machine that has a reduced air gap size of the can during operation because, by means deformation simulation and/or calculation in advance, allowance is made in production for regions of the can that are particularly loaded during operation, so that the loads during operation affect regions of the can that have been prepared and/or reinforced in this respect.

What is claimed is:

1. A can for an electric rotating machine, the can comprising:
a bearing seat; and
an asymmetric element on the can and/or on the bearing seat;
wherein the asymmetric element counteracts an expected deformation in loaded regions of the can, the expected deformation identified by measurement data and/or deformation simulation calculated in advance.

2. The can as claimed in claim 1, wherein the asymmetric element on the can comprises a negative form of a likely outward buckling and/or upward bending of the can.

3. The can as claimed in claim 1, wherein the asymmetric element comprises an eccentric position of the O-rings that serve for mounting and sealing the can.

4. The can as claimed in claim 1, wherein the asymmetric element comprises an arrangement and/or distribution of fiber reinforcement within the can.

5. The can as claimed in claim 1, wherein the can is partly symmetrical.

6. The can as claimed in claim 1, further comprising regions with glass fiber reinforcement.

7. The can as claimed in claim 1, further comprising regions with glass fiber reinforcement in combination.

8. The can as claimed in claim 1, further comprising regions with ultrahigh-modulus carbon fibers.

9. The can as claimed in claim 1, with an entirely or partially complex form.

10. A can comprising:
a bearing seat; and
O-ring seals separating the can from a rotor region of a electric rotating machine;
wherein the O-ring sealing is not arranged axially symmetrically in relation to a rotor axis.

11. A method of producing a can, the method comprising:
simulating a deformation and/or measuring operating loads imparted to the dimensional stability of the can due to hydrostatic pressure, vibration, and/or counter force of sealing O-rings;
generating and storing corresponding data with regard to likely particularly loaded regions of the can;
on the basis of these data, calculating positions of particularly loaded regions of the can;
creating a virtual representation of a can optimized with regard to the particularly loaded regions, wherein the regions are represented either by compacting and/or building up the fiber reinforcement, by complexity of the form and/or surface structure, and/or by an eccentric position of the O-rings, which are modified with respect to a round, axially symmetrically mounted can; and
forming and producing a can with modifications in accordance with the specifications of the virtual representation created.

12. (canceled)

13. The method as claimed in either of claims 11, performed using a winding process.

14. The method as claimed in claim 11, performed using a prepreg-autoclave technology.

15. (canceled)
